(19) United States
(12) Patent Application Publication
(10) Pub. No.: US 2006/0066718 A1
(43) Pub. Date: Mar. 30, 2006

(54) Apparatus and method for generating parallax image

(76) Inventors: Shingo Yanagawa, Kanagawa (JP); Yasunobu Yamauchi, Kanagawa (JP); Kazuki Taira, Tokyo (JP); Rieko Fukushima, Tokyo (JP); Tatsuo Saishu, Tokyo (JP); Yuzo Hirayama, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/086,232

(22) Filed: Mar. 23, 2005

(30) Foreign Application Priority Data
Sep. 29, 2004 (JP) 2004-285243

(51) Int. Cl. H04N 13/04; H04N 13/00; H04N 15/00

(52) U.S. Cl. 348/51; 348/42

(57) ABSTRACT

An apparatus for generating a parallax image to be used for a display of a three-dimensional image on a three-dimensional integral imaging display includes an image signal acquiring unit, an image signal assigning unit, and a parallax image generator. The image signal acquiring unit acquires a plurality of image signals by picking up an image of an image object from a plurality of different parallax directions. The image signal assigning unit assigns an output order of the plurality of image signal so that the plurality of image signals are arranged in a reverse parallax direction order to an order of beam directions of the three-dimensional integral imaging display. The parallax image generator generates a parallax image from the plurality of image signals to which an output order is assigned by the image signal assigning unit.

### CROSS-REFERENCE TO RELATED APPLICATIONS

This application is based upon and claims the benefit of priority from the prior Japanese Patent Application No. 2004-285243 filed on Sep. 29, 2004; the entire contents of which are incorporated herein by reference.

### BACKGROUND OF THE INVENTION

1) Field of the Invention

The present invention relates to an apparatus for and a method of generating a parallax image to be used for a display of a three-dimensional image on a three-dimensional integral imaging display, and a computer program product which makes a computer execute the method.

2) Description of the Related Art

Conventionally, as a technique for displaying a three-dimensional image with a two-dimensional display element, integral imaging (also called as integral photography) is known (see, for example, H. Hoshino, F. Okano, H. Isono and I. Yuyama “Analysis of resolution limitation of integral photography”, J. Opt. Soc. Am, A15 (1998) 2059-2065). According to the integral imaging, an optical image selecting unit synthesizes and displays images obtained from a plurality of directions of visual lines on an image display screen, and allows a selective image viewing depending on a position of viewpoint of a viewer.

In particular, as the optical image selecting unit, a beam directing unit constituted from slits, pin holes, or a lens array (lenticular lenses, for example) is used. The beam directing unit limits the pixels viewable from the viewpoint of the viewer. The beam directing unit and the display element are arranged in a proper geometrical dimension and a relative position and unit information corresponding to a direction of light beam that is emitted from each pixel provided on the display unit and passes through an aperture of the beam directing unit is assigned to the pixel, in order to achieve a three-dimensional image display which includes image information obtained from various viewpoints.

Here, the three-dimensional image can be defined as an image including a plurality of images each obtained from a certain viewpoint in a certain direction. Hereinbelow, an image obtained by viewing from a certain viewpoint in a predetermined direction is called a viewpoint image. A three-dimensional image achieved by the integral imaging is a display image where a plurality of viewpoint images are combined on unit information basis and spatially disposed.

Thus, the three-dimensional integral imaging display provides a three-dimensional image to the viewer by reproducing a plurality of light beams from different directions around the display.

Such a three-dimensional integral imaging display is desirable in that the display allows a precise display of different images depending on a position from which the viewer observes a display object, since the display reproduces the light beams around the display. According to the technique, however it is difficult to provide a three-dimensional image independent of the light beams at the time of the object image acquisition; for example, it is difficult to display a three-dimensional image which appears to be located in the same direction regardless of the position of the viewer of the display.

When a parallax image obtained by image pick-up of the image object from one direction is assigned to all parallax components, the three-dimensional integral imaging display can display an image which appears to be in the same direction regardless of the viewpoint of the viewer of the display. Such an image, however is a planar image, that is, non-three-dimensional image, which does not cause binocular parallax of the viewer. Multi-lens stereoscopic displays employ a parallax barrier or a lenticular lens to assign a different three-dimensional image to each eye of the viewer as a right-eye-image or a left-eye-image. Hence, when two images respectively for a right and a left eyes are input to the display based on an estimated eye separation, the viewer can observe a three-dimensional image that appears to be in the same direction regardless of the viewer's viewpoint as far as the viewer is in an area which allows observation according to the specification of the display.

According to the three-dimensional integral imaging display, however, parallax components in a viewing area need to be continuous. When parallax components are arranged alternately for the right eye and the left eye as in the multi-lens stereoscopic display mentioned above for the generation of multi-parallax image, the parallax components are not continuous and a resulting three-dimensional image appears to be blurred or overlapped.

### SUMMARY OF THE INVENTION

It is an object of the present invention to at least solve the problems in the conventional technology.

An apparatus for generating a parallax image to be used for a display of a three-dimensional image on a three-dimensional integral imaging display, according to one aspect of the present invention, includes an image signal acquiring unit that acquires a plurality of image signals by picking up an image of an image object from a plurality of different parallax directions; an image signal assigning unit that assigns an output order of the plurality of image signal so that the plurality of image signals are arranged in a reverse parallax direction order to an order of beam directions of the three-dimensional integral imaging display; and a parallax image generator that generates a parallax image from the plurality of image signals to which an output order is assigned by the image signal assigning unit.

A method of generating a parallax image to be used for a display of a three-dimensional image on a three-dimensional integral imaging display, according to another aspect of the present invention, includes acquiring a plurality of image signals by picking up an image of an image object from a plurality of different parallax directions; assigning an output order of the plurality of image signal so that the plurality of image signals are arranged in a reverse parallax direction order to an order of beam directions of the three-dimensional integral imaging display; and generating a parallax image from the plurality of image signals to which an output order is assigned.

The computer program product according to still another aspect of the present invention causes a computer to perform the method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a structure of an image generating apparatus according to a first embodiment;

FIG. 2 is a flowchart of a generating process of a parallax image;

FIG. 3 is an explanatory diagram of a display area of a three-dimensional integral imaging display;

FIG. 4 is a flowchart of an image signal assigning process;

FIG. 5 is an explanatory diagram of a content of a frame buffer storing parallax numbers and image signals in association with each other upon input from an image signal acquiring unit 101, and a content of a frame buffer storing parallax numbers and image signals in association with each other after an order change of the parallax numbers into reverse;

FIG. 6 is an explanatory diagram of light beams output from a conventional three-dimensional integral imaging display and a three-dimensional image observed from each viewer's direction;

FIG. 7 is an explanatory diagram of light beams output from the three-dimensional integral imaging display based on a generated parallax image and a three-dimensional image observed from each viewer's direction according to the first embodiment;

FIG. 8 is a block diagram of a structure of an image generating apparatus according to a modification of the first embodiment;

FIG. 9 is a block diagram of a structure of an image generating apparatus according to a second embodiment; and

FIG. 10 is a flowchart of a generating process of a parallax image.

### DETAILED DESCRIPTION

Exemplary embodiments of an apparatus, a method and a computer program for image generation according to the present invention will be explained in detail below with reference to the accompanying drawings.

An image generating apparatus according to a first embodiment assigns a plurality of image signals obtained by image pick-up of an image object from a plurality of different parallax directions in a reverse order from an order of directions of light beams output from a three-dimensional integral imaging display (hereinafter also referred to simply as a stereoscopic display device).

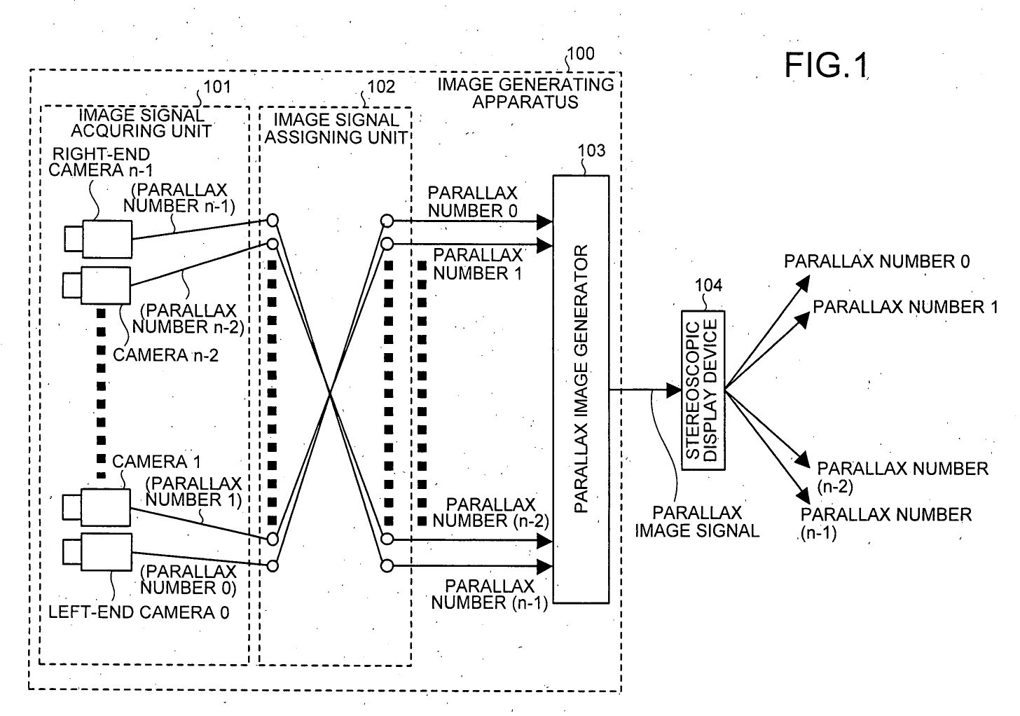

FIG. 1 is a block diagram of a structure of the image generating apparatus according to the first embodiment The image generating apparatus according to the first embodiment includes an image signal acquiring unit 101, an image signal assigning unit 102, and a parallax image generator 103, and is connected to a stereoscopic display device 104 as shown in FIG. 1.

The image signal acquiring unit 101 includes a plurality of cameras 0 to n-1 that pick up images of the image object from different viewpoints and acquires the images picked up by the respective cameras as image signals to supply to the image signal assigning unit 102.

The plurality of cameras 0 to n-1 are arranged in a horizontal direction with respect to the image object so that each camera picks up the image thereof from different parallax direction, thereby providing a multi-viewpoint image. Parallax numbers 0 to n-1 are assigned in an ascending order to image signals provided from the left-end camera 0 to the right-end camera n-1 to designate the parallax directions of the image signals from the respective cameras 0 to n-1.

The image signals are generated according to a known technique. Particularly, a viewpoint that serves as an image pick up position of the camera is set to determine a base plane of the image pick-up. Then a point of regard is set on the base plane. The viewpoint of the camera corresponds to the viewpoint of the viewer and the point of regard corresponds to a center of a screen of the stereoscopic display device 104. The cameras 0 to n-1 are arranged towards the base plane so that the base plane is aligned with a position of pupil of a beam directing unit and the image-pick up is conducted.

According to the embodiment, the image object is arranged either in an area in front of the point of regard up to a protrusion limit or in an area deeper than the point of regard up to a depth limit for the image pick-up by the cameras 0 to n-1. Details of such arrangement of the image object are explained later.

According to the embodiment, the cameras 0 to n-1 are employed for the acquisition of the image signals. The image signals, however, may be acquired through rendering by a virtual camera in a three-dimensional (3D) model space. The rendering is a process of image data drawing on a two-dimensional screen. In the rendering, the virtual camera and the point of regard are set. The virtual camera is a hypothetical camera arranged in a position determined corresponding to a light beam that is output from the stereoscopic display device, and arranged in front of a display panel of the stereoscopic display device 104 so that the virtual camera faces the center of the display panel. The point of regard is set in the center of the display panel.

The image signal assigning unit 102 receives image signals of the respective cameras 0 to n-1 from the image signal acquiring unit 101 to output the received image signals to the parallax image generator 103 in reverse order. In other words, the image signal assigning unit 102 assigns the image signals received from the image signal acquiring unit 101 in a reverse order from the order of directions of the light beams output from the stereoscopic display device 104.

In particular, when the parallax numbers of the image signals are designated by 0 to n-1 corresponding to the cameras 0 to n-1, as shown in FIG. 1, when the image signals are output from the image signal assigning unit 102 to the parallax image generator 103, the image signals are assigned in the order of parallax numbers n-1 to 0. Then, the image signals from the respective cameras are in reverse order of the directions of light beams output from the stereoscopic display device 104.

In a conventional image generating apparatus, the image signals from the respective cameras are assigned in the same order with the directions of light beams output from the stereoscopic display device 104 for the generation of the parallax image. In the image generating apparatus 100 according to the first embodiment, however, the image signals from the respective cameras are assigned in reverse order from the directions of light beams output from the stereoscopic display device 104, in order to allow stereoscopic display device 104 to exhibit an image which appears to be in the same direction regardless of the viewer's position.

The parallax image generator 103 receives a plurality of image signals to which the parallax numbers are assigned in reverse order from the parallax numbers of the image signals as output from the cameras, to generate the parallax image constituting a three-dimensional image of the image object.

The stereoscopic display device 104 displays a three-dimensional image according to the integral imaging technique. The stereoscopic display device 104 includes a display element (not shown) that forms an image from a plurality of pixel dots arranged in a two-dimensional manner and a beam directing unit (not shown) that limits the direction of light beams emitted from the pixel dots to limit a visual angle in the horizontal direction.

As the stereoscopic display device 104, a flat panel where pixel dots are arranged in a matrix is more preferable than a cathode-ray tube (CRT) or a projector, since misalignment of the pixel dots exerts a significant negative influence on the direction of light beam emission. Such a flat panel is, for example, a non-luminous liquid crystal display (LCD) panel, a luminous plasma display panel (PDP), or an organic electroluminescence (EL) panel. As the beam directing unit, lenticular lenses having a bus line in a direction perpendicular to the screen, or slits may be employed. Since the beam direction is limited to the direction horizontal to the screen, each bus line of the lenticular lens or each aperture of the slit does not necessarily be in a straight line shape arranged over the vertical direction of the screen and may be in a line or a dotted line shape as suitable for the pixel dot arrangement.

In addition, in the integral imaging stereoscopic display device 104 according to the embodiment, though there is no specific condition to be satisfied with respect to the beam direction, the pitch of the beam directing unit is set to an integral multiple of the pitch of the pixel dots, i.e. set equal to the pitch of a pixel group constituted from several pixel dots, in order to form a group of parallel beams to achieve an efficient generation of parallax image in practice.

The display of the three-dimensional image by the stereoscopic display device 104 is performed in the same manner as in the conventional stereoscopic display device.

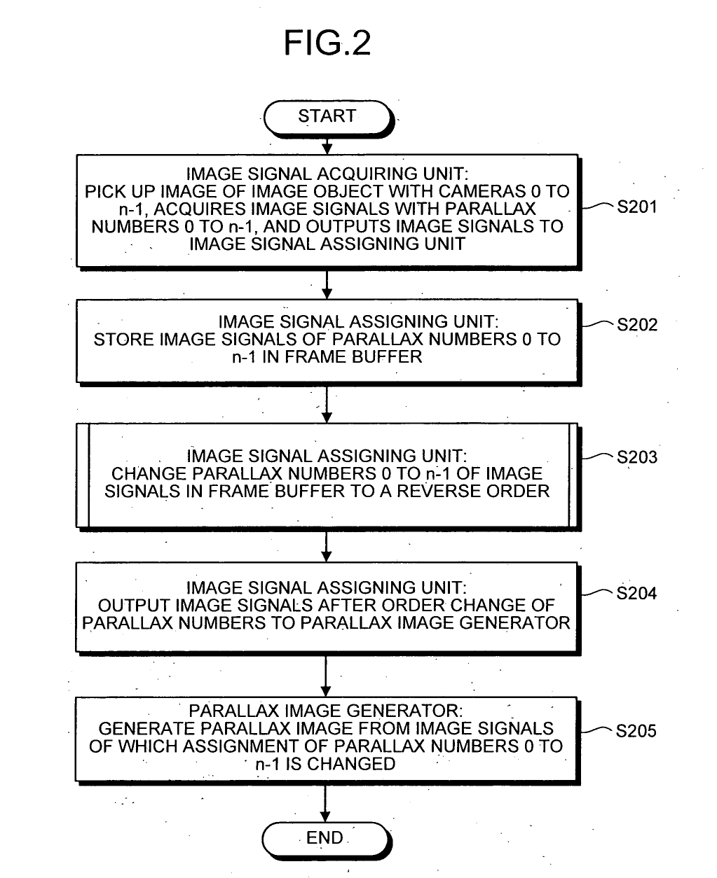

A generating process of the parallax image in the image generating apparatus 100 according to the embodiment is explained next. FIG. 2 is a flowchart of the generating process of the parallax image.

First, the image signal acquiring unit 101 picks up the image of the image object from various parallax directions by the cameras 0 to n-1 and acquires the image signals of the cameras 0 to n-1, designated by the parallax numbers 0 to n-1, respectively, to output the acquired image signals to the image signal assigning unit 102 (at step S201).

Here, the image signal assigning unit 102 assigns the parallax numbers 0 to n-1 in reverse order from the order of beam directions output from the integral imaging stereoscopic display device 104 to the image signals, which are supplied from the cameras 0 to n-1 each pick up the image of the image object from different viewpoint, in order to achieve the display of an image that appears to be in the same direction regardless of the viewer's viewpoint on the stereoscopic display device 104. Such processing, however, may cause the following inconvenience.

When the signals are processed as described above, the image picked up from the left side of the image object is observed by the right eye of the viewer, while the image picked up from the right side of the image object is observed by the left eye of the viewer. This phenomenon is called a reverse viewing or a reverse stereoscopic viewing. In the reverse viewing, a part of the image object located at a deeper position than the point of regard appears to be located at a shallower position, while a part of the image object located at a shallower position than the point of regard appears to be located at a deeper position. Hence, the viewer cannot correctly perceive the contour of the surface of the image object. To suppress the inconvenient effect, in the embodiment, the image object is placed either in an area in front of the point of regard up to the protrusion limit or in an area deeper than the point of regard up to the dept limit, and the cameras 0 to n-1 are employed for the image pick-up. Thus the inconsistency of the depth perception in the reverse viewing is alleviated.

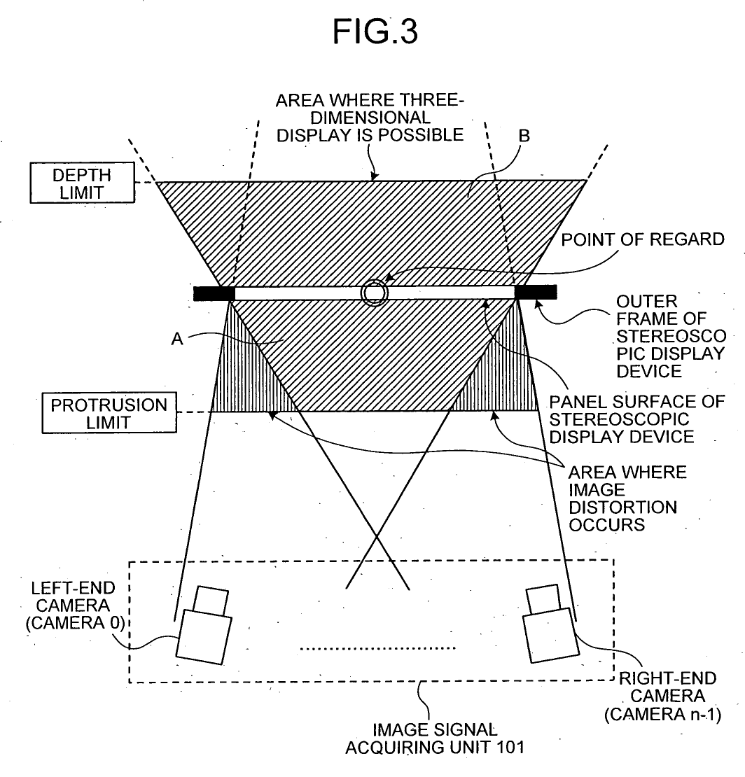

FIG. 3 is an explanatory diagram of a display area of the integral imaging stereoscopic display device 104. In FIG. 3, the image object is arranged either in an area A in front of the point of regard up to the protrusion limit or in an area B deeper than the point of regard up to the depth limit, and the cameras 0 to n-1 are employed for the image pick-up.

Return to FIG. 2, after the image signal acquiring unit 101 outputs the respective image signals to the image signal assigning unit 102 at the step 201, the image signal assigning unit 102 receives the image signals with the parallax numbers 0-n-1 from the image signal acquiring unit 101 and temporarily stores the received image signals with parallax numbers 0 to n-1 in a frame buffer in association with the respective parallax numbers (at step S202). Then, the image signal assigning unit 102 changes the parallax numbers 0 to n-1 of the image signals in the frame buffer to the reverse order, i.e., to the order of n-1 to 0 (at step S203). Then, the image signal assigning unit 102 outputs the respective image signals with the parallax numbers in reverse order to the parallax image generator 103 (at step S204). Details of the assigning process of the image signals at the step S203 are explained later.

Next, the parallax image generator 103 receives the respective image signals with the parallax numbers in reverse order from the image signal assigning unit 102 to generate the parallax image from the respective image signals with the parallax numbers 0 to n-1 (at step S205).

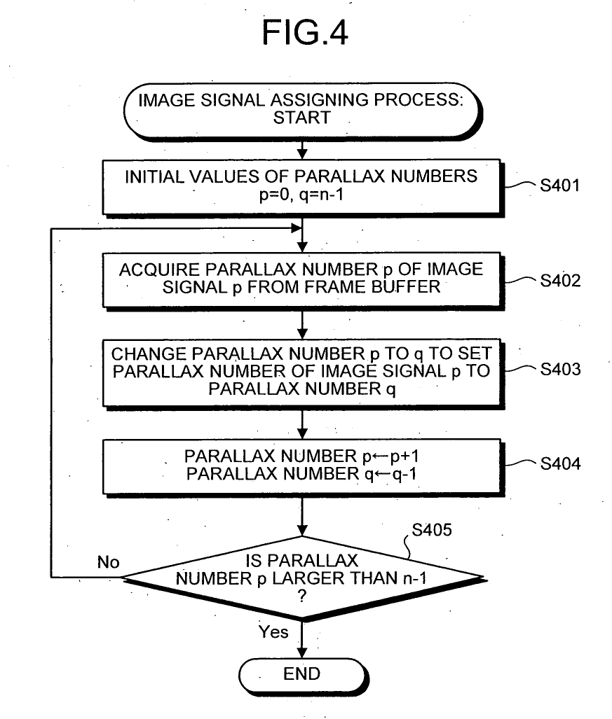

Next, the image signal assigning process by the image signal assigning unit 102 at the step S203 is explained. FIG. 4 is a flowchart of the image signal assigning process. Hereinbelow, an image signal with a parallax number p upon reception thereof from the image signal acquiring unit 101 is denoted as an image signal p.

In the image signal assigning unit 102, initial values of parallax numbers p and q are set as p=0, q=n-1 (at step S401). Here, n-1 denotes the maximum of the parallax number, i.e., the number of cameras.

Then, the image signal assigning unit 102 acquires the parallax number p of the image signal p from the frame buffer (at step S402). Then, the image signal assigning unit 102 changes the acquired parallax number p to q, thereby setting the parallax number of the image signal p to q (at step S403). Then, the image signal assigning unit 102 increases the value of the parallax number p by one and decreases the value of the parallax number q by one (at step S404). The image signal assigning unit 102 determines whether the parallax number p is larger than the maximum parallax number n-1 (at step S405). When the parallax number p is determined to be equal to or smaller than the maximum (No at the step S405), the image signal assigning unit 102 repeats the process from the step S402 to the step S404.

When the parallax number p is determined to be larger than the maximum parallax number n-1 at the step S405 (Yes at the step S405), the image signal assigning process ends.

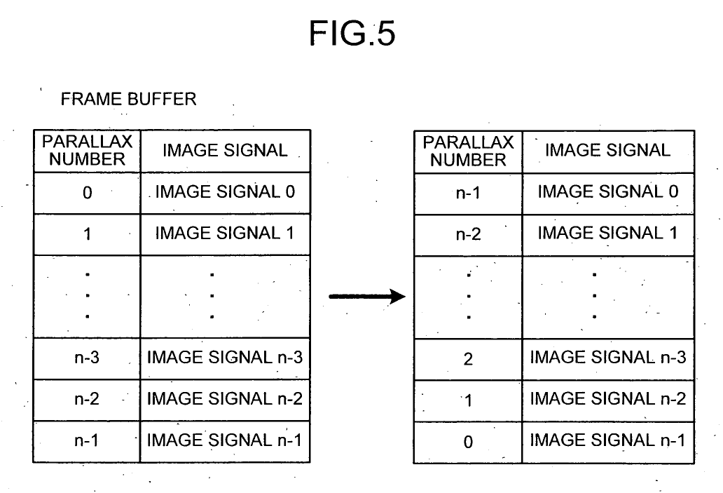

Thus, the parallax numbers of the image signals are changed to the reverse order. FIG. 5 is an explanatory diagram of a content of a frame buffer storing the parallax numbers and the image signals in association with each other at the reception thereof from the image signal acquiring unit 101 and a content of a frame buffer storing the parallax numbers and the image signals in association with each other after the change of the parallax number in reverse order. As shown in FIG. 5, before the change, the parallax numbers 0 to n-1 are assigned to the image signals 0 to n-1 in order, whereas after the change, the parallax numbers are reversed and the parallax numbers n-1 to 0 are assigned to the image signals 0 to n-1, respectively.

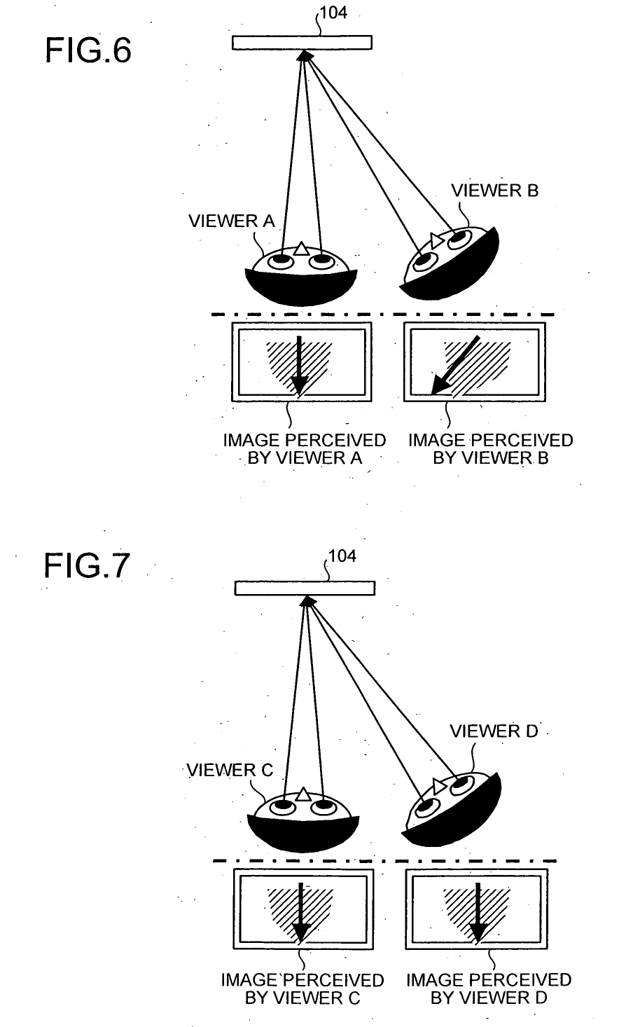

In the conventional image generating apparatus, the image signals from the respective cameras are assigned in an order of the beam directions output from the stereoscopic display device 104 to generate the parallax image and to display the three-dimensional image on the stereoscopic display device. Hence, as shown in FIG. 6, it is possible to display different three-dimensional images according to the viewing positions of the viewers, such as a viewer A and a viewer B. However it is not possible to display a three-dimensional image which appears to be the same regardless of the difference in viewer's position and direction of viewpoint, as in the case of viewers C and D shown in FIG. 7.

In the image generating apparatus 100 according to the first embodiment, since the respective image signals output from the cameras 0 to n-1 of the image signal acquiring unit 101 are assigned in a reverse order of the beam directions output from the stereoscopic display device 104, the integral imaging stereoscopic display device 104 can provide a three-dimensional image that appears to be in the same direction so that the viewer feels as if he/she observes the image object from the same direction even when he/she moves to a different position.

Though in the embodiment, the assigning process by the image signal assigning unit 102 is realized through the processing by software, the process may be realized with a hardware including a unit for assigning the respective received image signal inputs in a reverse order of the parallax directions to provide the outputs to the parallax image generator 103.

In addition, though the parallax image generated by the parallax image generator 103 is directly sent to the stereoscopic display device 104 for the display of the three-dimensional image in the embodiment, the parallax image generated by the parallax image generator 103 may be temporarily stored in a storing unit as a modification of the first embodiment.

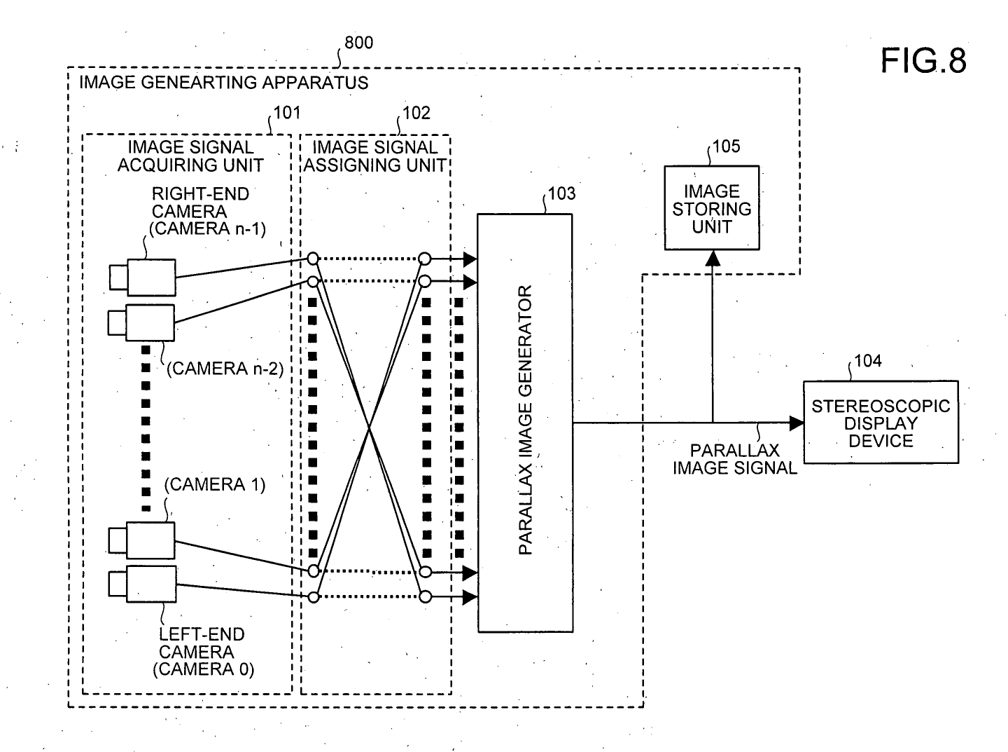

FIG. 8 is a block diagram of a structure of an image generating apparatus according to a modification of the first embodiment. As shown in FIG. 8, an image generating apparatus 800 according to the modification is provided with an image storing unit 105 that stores the parallax image generated by the parallax image generator 103. As such image storing unit 105, a recording medium such as a hard disc drive (HDD) or a memory is used.

In the image generating apparatus according to the modification, after the parallax image generator 103 generates the parallax image from the plurality of image signals with the parallax numbers assigned in reverse order to the parallax directions, the image storing unit 105 stores the generated parallax image. Then, the parallax image stored in the image storing unit 105 is sent to the stereoscopic display device 104 when a display request from the stereoscopic display device 104 is received by the image generating apparatus 800.

In addition, the image storing unit 105 may not be provided in the image generating apparatus 100. The image storing unit 105 may be connected between the image generating apparatus 800 and the stereoscopic display device 104 as shown in FIG. 8 so that the stereoscopic display device 104 reads the parallax image in the image storing unit 105.

In the image generating apparatus 100 according to the first embodiment, when the image signal acquiring unit 101 acquires the plurality of image signals, the parallax numbers are always assigned in reverse order to the parallax directions. In an image generating apparatus according to a second embodiment, the image signal acquiring unit acquires the plurality of image signals and dynamically changes the order of the parallax numbers with respect to the parallax directions according to a switching direction which indicates either a descending order (reverse order) or an ascending order (unchanged order).

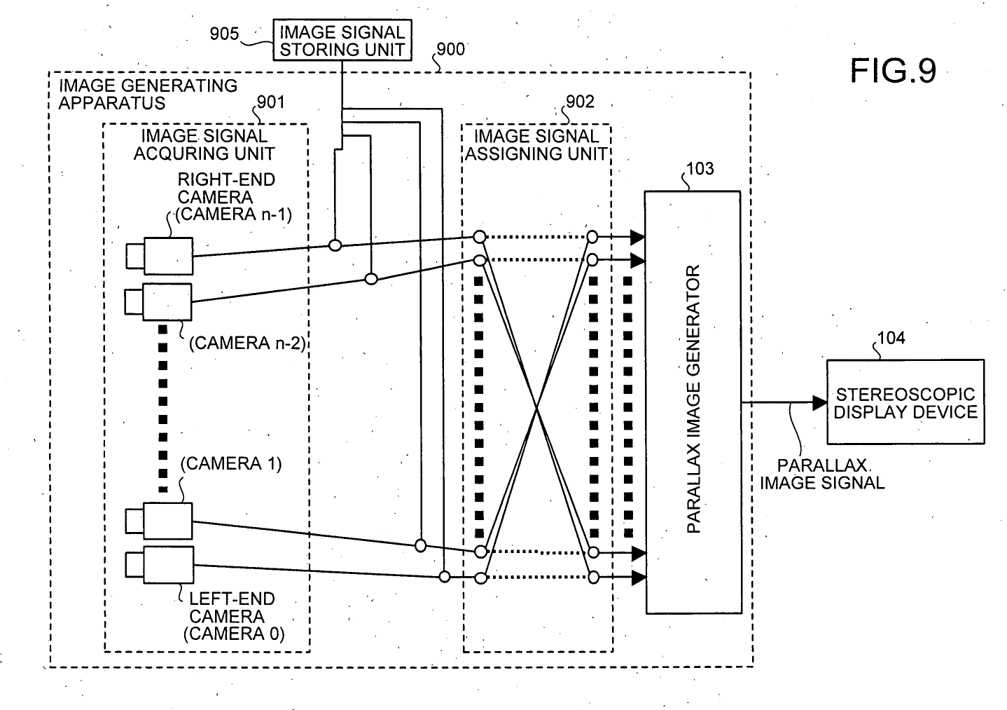

FIG. 9 is a block diagram of a structure of an image generating apparatus 900 according to the second embodiment. The image generating apparatus 900 according to the second embodiment includes an image signal acquiring unit 901, an image signal assigning unit 902, the parallax image generator 103, and an image signal storing unit 905, and is connected to the stereoscopic display device 104 as shown in FIG. 9.

The image signal acquiring unit 901 is provided with the plurality of cameras 0 to n-1 that pick up the image of the image object from various viewpoints in the same manner as in the first embodiment The image signal acquiring unit 901 according to the second embodiment acquires the images picked up by the respective cameras as the image signals to store the acquired image signals in the image signal storing unit 905.

Here, the plurality of cameras 0 to n-1 are arranged in a horizontal direction with respect to the image object so that the cameras pick up the image of the image object from different viewpoints at different parallax directions as in the first embodiment. The parallax numbers 0 to n-1 are assigned in ascending order to the image signals from the respective cameras from the left-end camera 0 to the right-end camera n-1 in order to designate the parallax directions of the image signals from the respective cameras 0 to n-1.

The image signal storing unit 905 serves to store the plurality of image signals with the respective parallax numbers acquired by the image signal acquiring unit 901, and in particular is a recording medium such as a HDD or a memory.

The image signal assigning unit 902 acquires the respective image signals stored in the image signal storing unit 905 and assigns the image signals of the respective cameras in the same order or in the reverse order of the image signals to be supplied to the parallax image generator 103, i.e., the beam directions output from the stereoscopic display device. Particularly, the image signal assigning unit 902 receives a switching direction from a user via an input device (not shown) and, when the switching direction indicates a reverse order switching, supplies the image signals of the parallax numbers 0 to n-1 as the image signals with the parallax numbers n-1 to 0 to the parallax image generator 103 in the same manner as in the first embodiment.

On the other hand, when the switching direction indicates a same order switching, the image signal assigning unit 902 supplies the image signals with the parallax numbers 0 to n-1 to the parallax image generator 103 without changing the order of the parallax numbers (i.e. in the same order).

The parallax image generator 103, similarly to the first embodiment, receives the plurality of image signals with the parallax numbers assigned by the image signal assigning unit 902 in the reverse order from the parallax numbers of the image signals as received from the respective cameras, to generate the parallax image constituting the three-dimensional image of the image object. The stereoscopic display device 104, similarly to the first embodiment, displays the three-dimensional image according to the integral imaging technique.

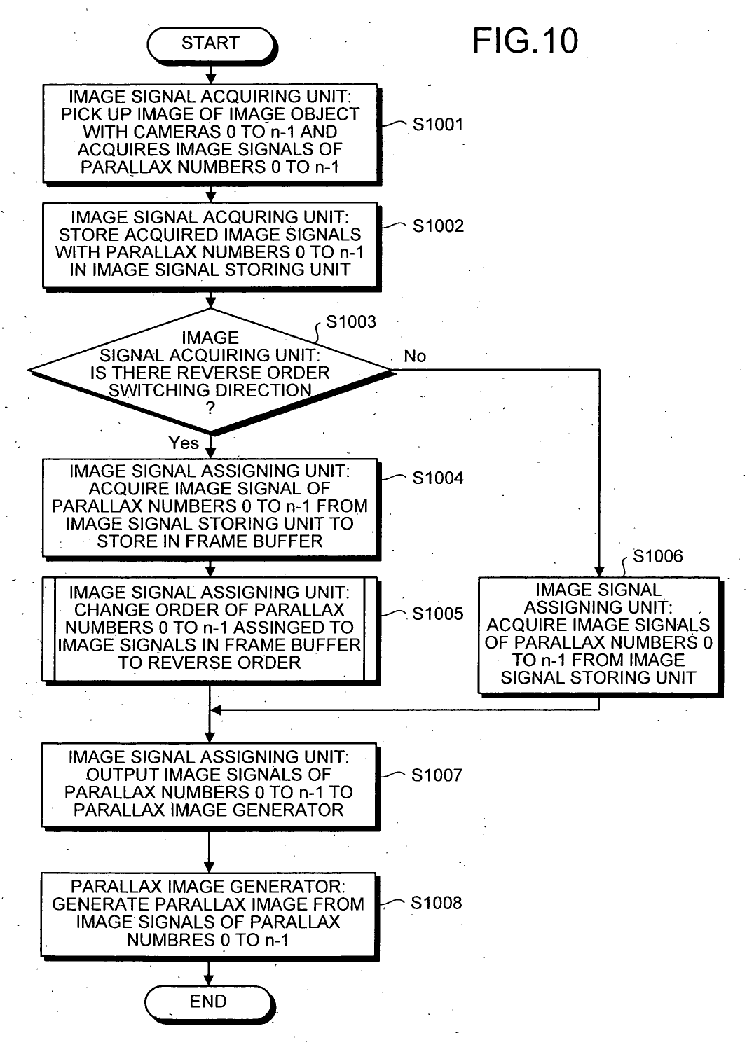

A generating process of the parallax image by the image generating apparatus 900 according to the second embodiment is explained next. FIG. 10 is a flowchart of the generating process of the parallax image.

The image signal acquiring unit 901 picks up the images of the image object from various parallax directions with the plurality of cameras 0 to n-1 to acquire the image signals of the parallax numbers 0 to n-1 from the cameras 0 to n-1 (at step S1001). Then, the image signal acquiring unit 901 stores the acquired image signals in the image signal storing unit 905 (at step S1002).

The image signal assigning unit 902 receives a direction from a user via an input device (not shown) and determines whether the received direction is a reverse order switching direction or not (at step S1003). When the received direction is the reverse order switching direction (Yes at the step S1003), the image signal assigning unit 902 acquires the image signals of the parallax numbers 0 to n-1 from the image signal storing unit 905 and stores the acquired image signals with the parallax numbers 0 to n-1 in a frame buffer maintaining the association between the image signals and the parallax numbers (at step S1004). Then, the image signal assigning unit 902 changes the parallax numbers 0 to n-1 of the image signals in the frame buffer to the reverse order, i.e., to the order of the parallax numbers n-1 to 0 (at step S1005). The image signal assigning unit 902 supplies the respective image signals with changed order of parallax numbers to the parallax image generator 103 (at step S1007). Here, the assigning process of the image signals at the step S1005 is conducted in the same manner as in the first embodiment as explained with reference to FIG. 4.

The parallax image generator 103 receives the respective image signals with the parallax numbers changed into the reverse order from the image signal assigning unit 902, to generate the parallax image from the respective image signals with the parallax numbers 0 to n-1 (at step S1008).

When the received direction at the step S1003 is not the reverse order switching direction, i.e., is a same order switching direction (No at the step S1003), the image signal assigning unit 902 acquires the image signals of the parallax numbers 0 to n-1 from the image signal storing unit 905 to output the acquired image signals to the parallax image generator 102 without changing the order of the parallax numbers (at step S1007).

Then, the parallax image generator 103 receives the respective image signals with the parallax numbers in the unchanged order from the image signal assigning unit 902, to generate the parallax image from the respective signals with the parallax numbers 0 to n-1 (at step S1008).

Thus, in the image generating apparatus 900 according to the second embodiment, the image signal acquiring unit 901 acquires the plurality of image signals to temporarily store the image signals in the image signal storing unit 905 and the order of the parallax numbers is dynamically switched according to the direction from the user, i.e. according to the reverse order switching direction or the same order switching direction. Hence, in the integral imaging stereoscopic display device 104, it is possible to switch the three-dimensional image of the image object to be displayed from an image that appears to be in the same direction regardless of the viewing direction of the viewer to an image that appears to be different depending on the viewing direction of the viewer. Thus, more flexible display of the three-dimensional image can be achieved.

The image generating apparatus according to the first or the second embodiment has a hardware structure utilizing an ordinary computer and includes a controller such as a central processing unit (CPU), a storing unit such as a read only memory (ROM) or a random access memory (RAM), an external storing unit such as a HDD or a compact disc (CD) drive, a display, and an input unit such as a keyboard or a mouse.

An image generating program executed in the image generating apparatus according to the first or the second embodiment is recorded in a computer readable recording medium such as a CD-ROM, a flexible disc (FD), a CD-R, a digital versatile disc (DVD) in the form of an installable or executable file.

The image generating program executed in the image generating apparatus according to the first or the second embodiment may be stored in a computer connected to a network such as the Internet, and downloaded via the network. Further, the image generating program executed in the image generating apparatus of the first or the second embodiment may be provided or distributed via a network such as the Internet. Still further, the image generating program of the first and the second embodiments may be incorporated into a ROM or the like in advance.

The image generating program executed by the image generating apparatus of the first or the second embodiment has a module structure including above-described units such as the image signal assigning unit and the parallax generator. In the actual hardware, the CPU reads out the image generating program from the recording medium and executes the program to load the respective units on the main memory thereby generating the image signal assigning unit, the parallax image generator or the like on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for generating a parallax image to be used for a display of a three-dimensional image on a three-dimensional integral imaging display, comprising:
an image signal acquiring unit that acquires a plurality of image signals by picking up an image of an image object from a plurality of different parallax directions;
an image signal assigning unit that assigns an output order of the plurality of image signal so that the plurality of image signals are arranged in a reverse parallax direction order to an order of beam directions of the three-dimensional integral imaging display; and
a parallax image generator that generates a parallax image from the plurality of image signals to which an output order is assigned by the image signal assigning unit.

2. The apparatus according to claim 1, wherein
the image signal assigning unit assigns parallax identification information for identifying each parallax direction to the plurality of image signals obtained from the image signal acquiring unit in a reverse order of the order of the parallax directions in the image signal acquiring unit; and
the parallax image generator generates the parallax image from the plurality of image signals to which the parallax identification information is assigned in the reverse order of the order of the parallax directions by the image signal assigning unit.

3. The apparatus according to claim 1, further comprising an image storing unit that stores the parallax image, wherein
the parallax image generator further stores the generated parallax image in the image storing unit.

4. The apparatus according to claim 2, further comprising an image storing unit that stores the parallax image, wherein
the parallax image generator further stores the generated parallax image in the image storing unit.

5. The apparatus according to claim 1, wherein
the image signal assigning unit, in response to an instruction of reverse order assignment, assigns the output order of the plurality of image signals so that the plurality of image signals acquired from the image signal acquiring unit is arranged in a reverse order of an order of beam directions of the three-dimensional integral imaging display.

6. The apparatus according to claim 2, wherein
the image signal assigning unit, in response to an instruction of reverse order assignment, assigns the output order of the plurality of image signals so that the plurality of image signals acquired from the image signal acquiring unit is arranged in a reverse order of an order of beam directions of the three-dimensional integral imaging display.

7. The apparatus according to claim 3, wherein
the image signal assigning unit, in response to an instruction of reverse order assignment, assigns the output order of the plurality of image signals so that the plurality of image signals acquired from the image signal acquiring unit is arranged in a reverse order of an order of beam directions of the three-dimensional integral imaging display.

8. The apparatus according to claim 5, further comprising an image signal storing unit that stores the plurality of image signals acquired by the image signal acquiring unit, wherein
the image signal assigning unit, in response to an instruction of reverse order assignment, assigns the output order of the plurality of image signals so that the plurality of image signals stored in the image signal storing unit are arranged in a reverse parallax direction order of the order of the beam directions of the three-dimensional integral imaging display.

9. The apparatus according to claim 6, further comprising an image signal storing unit that stores the plurality of image signals acquired by the image signal acquiring unit, wherein
the image signal assigning unit, in response to an instruction of reverse order assignment, assigns the output order of the plurality of image signals so that the plurality of image signals stored in the image signal storing unit are arranged in a reverse parallax direction order of the order of the beam directions of the three-dimensional integral imaging display.

10. The apparatus according to claim 7, further comprising an image signal storing unit that stores the plurality of image signals acquired by the image signal acquiring unit, wherein
the image signal assigning unit, when the reverse order assignment is instructed, assigns the output order of the plurality of image signals so that the plurality of image signals stored in the image signal storing unit are arranged in a reverse parallax direction order of the order of the beam directions of the three-dimensional integral imaging display.

11. The apparatus according to claim 1, wherein
the image signal acquiring unit acquires the plurality of image signals from the plurality of different parallax directions with respect to the image object arranged in one of an area in front of a point of regard up to a protrusion limit and an area deeper than the point of regard up to a depth limit.

12. The apparatus according to claim 2, wherein
the image signal acquiring unit acquires the plurality of image signals from the plurality of different parallax directions with respect to the image object arranged in one of an area in front of a point of regard up to a protrusion limit and an area deeper than the point of regard up to a depth limit.

13. The apparatus according to claim 3, wherein
the image signal acquiring unit acquires the plurality of image signals from the plurality of different parallax directions with respect to the image object arranged in one of an area in front of a point of regard up to a protrusion limit and an area deeper than the point of regard up to a depth limit.

14. The apparatus according to claim 5, wherein
the image signal acquiring unit acquires the plurality of image signals from the plurality of different parallax directions with respect to the image object arranged in one of an area in front of a point of regard up to a protrusion limit and an area deeper than the point of regard up to a depth limit.

15. The apparatus according to claim 8, wherein
the image signal acquiring unit acquires the plurality of image signals from the plurality of different parallax directions with respect to the image object arranged in one of an area in front of a point of regard up to a protrusion limit and an area deeper than the point of regard up to a depth limit.

16. A method of generating a parallax image to be used for a display of a three-dimensional image on a three-dimensional integral imaging display, comprising:
acquiring a plurality of image signals by picking up an image of an image object from a plurality of different parallax directions;
assigning an output order of the plurality of image signal so that the plurality of image signals are arranged in a reverse parallax direction order to an order of beam directions of the three-dimensional integral imaging display; and
generating a parallax image from the plurality of image signals to which an output order is assigned.

17. A computer program product having a computer readable medium including programmed instructions for generating a parallax image to be used for a display of a three-dimensional image on a three-dimensional integral imaging display, wherein the instructions, when executed by a computer, cause the computer to perform:
acquiring a plurality of image signals by picking up an image of an image object from a plurality of different parallax directions;
assigning an output order of the plurality of image signal so that the plurality of image signals are arranged in a reverse parallax direction order to an order of beam directions of the three-dimensional integral imaging display; and
generating a parallax image from the plurality of image signals to which an output order is assigned.
